(19) United States
(12) Patent Application Publication
(10) Pub. No.: US 2016/0314893 A1
(43) Pub. Date: Oct. 27, 2016

(54) ELECTRICAL TRANSFORMER BARRIER STRUCTURE

(71) Applicant: ABB Technology AG, Zurich (CH)

(72) Inventor: Zepu Wang, Christiansburg, VA (US)

(21) Appl. No.: 14/696,529

(22) Filed: Apr. 27, 2015

(51) Int. Cl. H01F 27/28; H01F 27/24

(52) U.S. Cl. CPC H01F 27/2823; H01F 27/24

(57) ABSTRACT

One or more electrical transformers comprising barrier structures for improved flashover resistance are provided herein. A barrier structure may be positioned between a higher voltage winding and a lower voltage winding, between the higher voltage winding and a core, or between two higher voltage windings of a multi-phase electrical transformer. The barrier structure may comprise a first material having a relatively lower permittivity value such as about 2.5 or less, which may provide improved flashover resistance. In an example, the barrier structure may comprise a second material having a relatively higher permittivity value such as about 2.5 or greater, which may provide improved puncture resistance. The barrier structure may comprise any number of layers of the first material and/or the second material

### BACKGROUND

An electrical transformer is a device that transfers electric energy from one circuit or winding to another circuit or winding through inductively coupled conductors. Varying current in a primary winding creates a varying magnetic flux in a ferromagnetic core of the electrical transformer, which results in a varying magnetic field through a secondary winding. The varying magnetic field induces a varying voltage in the secondary winding. When a load is connected to the secondary winding, an electric current will flow in the secondary winding and electrical energy will be transferred from a primary circuit, connected to the primary winding, through the transformer and the secondary winding to the load. A ratio of the number of windings in the secondary winding to the number of windings in the primary winding corresponds to a relationship between an induced voltage of the secondary winding and a voltage of the primary winding. Increasing the number of secondary windings in relation to the number of primary windings will result in an increased voltage output through the secondary winding. Increasing the number of primary windings in relation to the number of secondary windings will result in a decreased voltage output through the secondary winding. In this way, the transformer may step up or step down the output voltage of the secondary winding. For example, a first electrical transformer may be used to raise a voltage of electric power that is to be transmitted over a long distance in order to compensate for power losses from electric resistance of electrical cables. A second electrical transformer may be used to lower the voltage of the electric power after transmission to values suitable for user equipment.

Dielectric barriers may be used to protect an electrical transformer against electrical failures, such as an occurrence of an arc from a higher voltage winding to a lower voltage winding. However, a dielectric barrier may fail due to puncture and/or flashover. Puncture of the dielectric barrier may occur from electric stress that punctures a hole through the dielectric barrier, and thus an arc flash may occur from the higher voltage winding, through the hole, to the lower voltage winding, which may result in an electrical failure. Flashover may occur where an arc flash reaches the dielectric barrier and goes around the dielectric barrier by traveling from the higher voltage winding, along a surface of the dielectric barrier, and around the dielectric barrier to the lower voltage winding, which may result in an electrical failure.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, an electrical transformer is provided herein. The electrical transformer comprises a first lower voltage winding wrapped around a core. The electrical transformer comprises a first higher voltage winding wrapped around the lower voltage winding and the core. In an example, the electrical transformer comprises a barrier structure positioned between the first lower voltage winding and the first higher voltage winding (e.g., the barrier structure may comprise a relatively flexible material such that the barrier structure may be formed according to a cylindrical shape between the first lower voltage winding and the first higher voltage winding). In another example, the barrier structure is positioned between the first higher voltage winding and the core and/or one or more core yokes, such as between the first lower voltage winding and the core. In another example where the electrical transformer comprises a second lower voltage winding wrapped around a second core and a second higher voltage winding wrapped around the second lower voltage winding and the second core, the barrier structure is positioned between the first higher voltage winding and the second higher voltage winding. The barrier structure comprises a first material having a permittivity value of about 2.5 or less, such as about 2 or less. In an example, the first material comprises a polymeric foam insulation. In an example, the barrier structure comprises a second material having a permittivity value of about 2.5 or more, such as where the first material is formed into a first layer and the second material is formed into a second layer. In an example, the barrier structure may be formed between air spaces between conductors such as lower voltage windings and higher voltage windings. For example, the electrical transformer may comprise a first conductor (e.g., a higher voltage winding), a first air space, the barrier structure, a second air space, and a second conductor (e.g., a lower voltage winding).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is an example of a top down view of an electrical transformer comprising a barrier structure positioned between a higher voltage winding and a lower voltage winding.

FIG. 1B is an example of a cross sectional view of an electrical transformer comprising a barrier structure positioned between a higher voltage winding and a lower voltage winding.

FIG. 2A is an example of a top down view of an electrical transformer comprising one or more barrier structures positioned between higher voltage windings.

FIG. 2B is an example of a cross sectional view of an electrical transformer comprising one or more barrier structures positioned between higher voltage windings.

FIG. 3 is an example of a cross sectional view of an electrical transformer comprising a barrier structure positioned between a higher voltage winding and a core.

FIG. 4 is an example of a barrier structure comprising 2 layers.

FIG. 5 is an example of a barrier structure comprising 3 layers.

FIG. 6 is an example of a barrier structure comprising 3 layers.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

A barrier structure may be used within an electrical transformer, such as a dry-type transformer, to provide an insulative barrier for protecting against electrical failures. For example, the barrier structure may be positioned between a lower voltage winding and a higher voltage winding of the electrical transformer. Unfortunately, the barrier structure may fail to protect the electrical transform against an electrical failure due to puncture and/or flashover. Puncture of the barrier structure may occur from electric stress that punctures a hole through the barrier structure, and thus an arc flash may occur from the higher voltage winding, through the hole, to the lower voltage winding, which may result in an electrical failure. Flashover may occur where an arc flashes reaches the barrier structure and goes around the barrier structure by traveling from the higher voltage winding, along a surface of the barrier structure, and around the barrier structure to the lower voltage winding, which may result in an electrical failure. The barrier structure may be made of a relatively higher permittivity material (e.g., solid sheet insulation, biaxial stretched polyester film, calendered aramid paper, laminated films, polyimide film, sheet insulation of composite material with polymer and inorganic fillers, or other material having a permittivity value, such as a dielectric constant, above 2.5) in order to provide improved resistance to puncture. However, the relatively higher permittivity material may not provide adequate flashover resistance.

Accordingly, as provided herein, relatively lower permittivity material (e.g., a material, such as polymeric foam insulation, non-woven fibrous sheet such as Dacron sheet, pressboard, laminates, uncalendered aramid paper such as Nomax 411 paper, a fibre material, a film, etc., having a permittivity value of about 2.5 or less, such as about 2 of less) may be used for the barrier structure to provide improved flashover resistance. In an example, the barrier structure may comprise a first material having a permittivity value of about 2.5 or less and/or a temperature resistivity of 155 Celsius or more in order to withstand operating temperatures of the electrical transformer. In an example, the barrier structure may comprise a second material having a permittivity value of about 2.5 or more, which may provide improved puncture resistance due to having a relative higher density and/or dielectric withstand strength. The second material may comprise a biaxial stretched polyester film, a calendered aramid paper, a layering of polyester fiber and polyester film (e.g., a polyester film layer that is between two polyester fiber layers), a polyimide film, sheet insulation of composite material with polymer and inorganic fillers, a laminated film containing one or more of the above material, etc. The barrier structure may comprise the first material as a first layer and the second material as a second layer. The barrier structure may comprise any number of layers comprising the first material, the second material, and/or any other material.

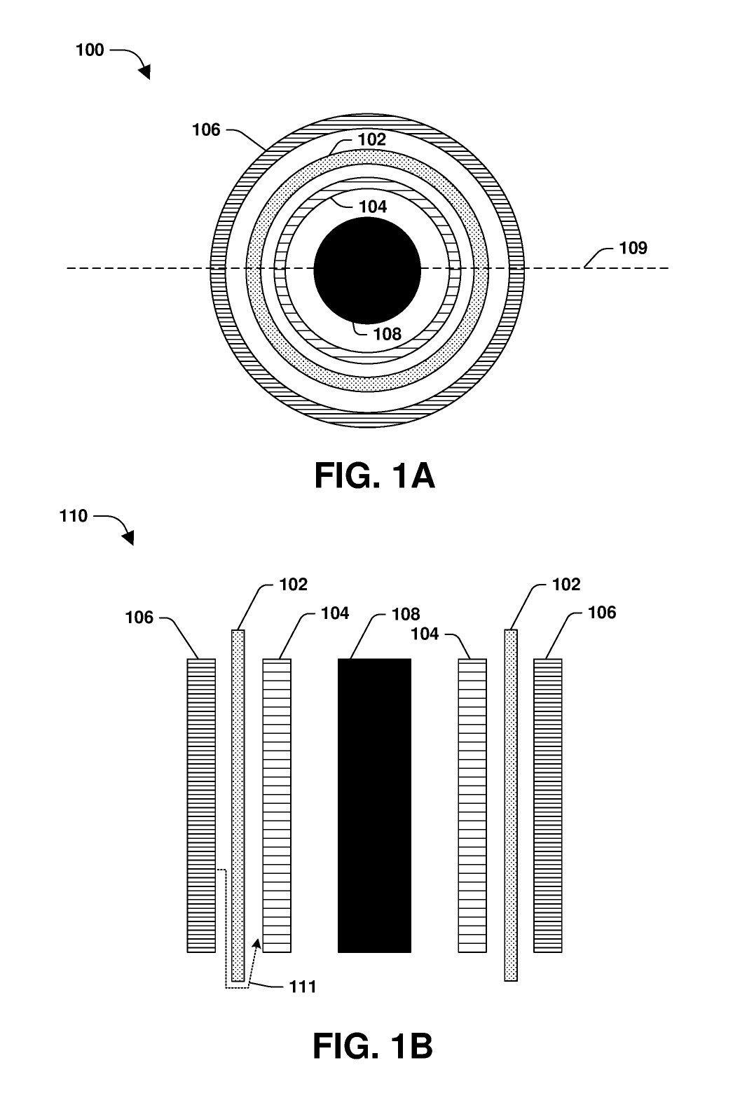

FIGS. 1A and 1B illustrate an example of an electrical transformer. FIG. 1A illustrates an example 100 of a top down view of the electrical transformer, and FIG. 1B illustrates an example 110 of a cross sectional view taken along a line 109 of FIG. 1A. The electrical transformer comprises a core 108 (e.g., an iron core used for circulation of magnetic flow). The electrical transformer comprises a lower voltage winding 104 (e.g., a winding for a voltage of several hundred volts or any other voltage) wrapped around the core 108. The electrical transformer comprises a higher voltage winding 106 (e.g., a winding for a voltage between 2 kv to 100 kv or any other voltage) wrapped around the lower voltage winding 104 and the core 108. The electrical transformer comprises a barrier structure 102 positioned between the higher voltage winding 106 and the lower voltage winding 104.

In an example, the barrier structure 102 comprises a cylindrical shape around the core 108. The barrier structure 102 comprises a first material with a relatively lower permittivity value, such as a material having a permittivity value of about 2.5 or less (e.g., a permittivity value between about 2 and about 1). In an example, the barrier structure 102 comprises a second material (not illustrated) with a relatively higher permittivity value, such as a material having a permittivity value of about 2.5 or more. The barrier structure 102 may comprise any number of layers comprising the first material and/or the second material (e.g., a first layer comprising the first material, a second layer comprising the second material, etc.). The second material, having the relatively higher permittivity value, may provide puncture resistance while the first material, having the relatively lower permittivity value, may provide flashover resistance. For example, the first material may mitigate, due to having the relatively lower permittivity value, a flashover of an arc 111 that would otherwise travel from the higher voltage winding 106 to the barrier structure 102, along a surface of the barrier structure 102, and to the lower voltage winding 104 to cause an electrical failure.

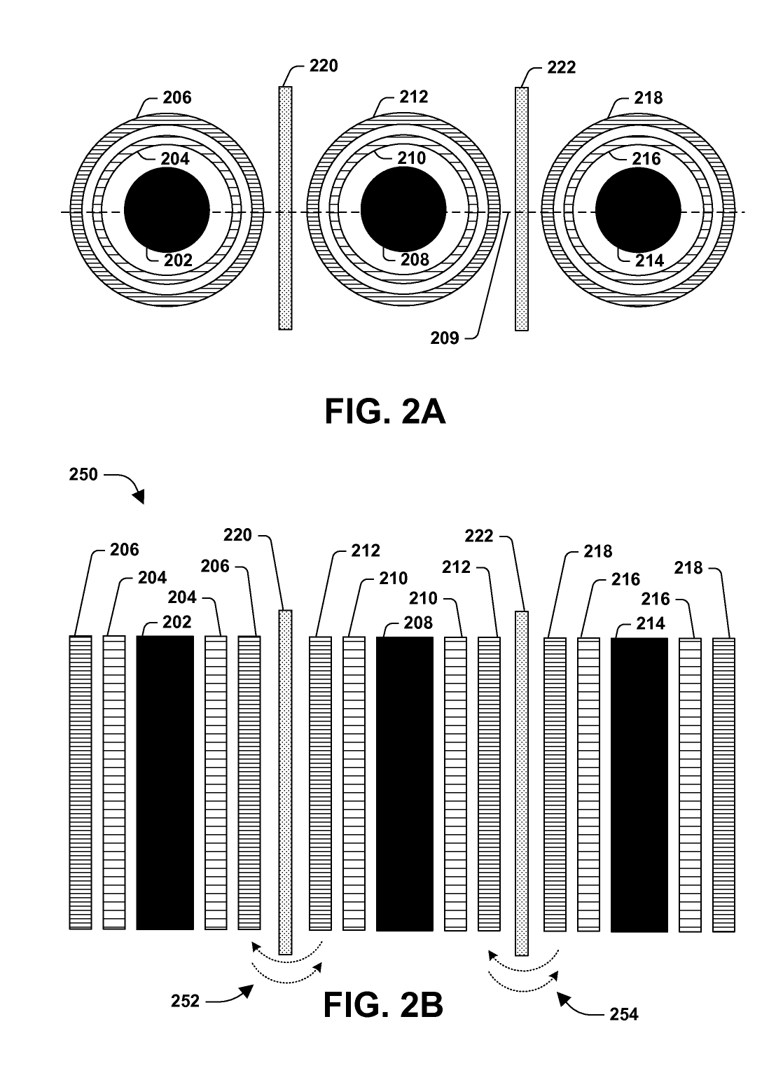

FIGS. 2A and 2B illustrate an example of an electrical transformer, such as a three phase transformer. FIG. 2A illustrates an example 200 of a top down view of the electrical transformer, and FIG. 2B illustrates an example 250 of a cross sectional view taken along a line 209 of FIG. 2A. The electrical transformer comprises a first transformer leg comprising a first core 202, a first lower voltage winding 204 wrapped around the first core 202, and a first higher voltage winding 206 wrapped around the first lower voltage winding 204 and the first core 202. The electrical transformer comprises a second transformer leg comprising a second core 208, a second lower voltage winding 210 wrapped around the second core 208, and a second higher voltage winding 212 wrapped around the second lower voltage winding 210 and the second core 208. The electrical transformer comprises a third transformer leg comprising a third core 214, a third lower voltage winding 216 wrapped around the third core 214, and a third higher voltage winding 218 wrapped around the third lower voltage winding 216 and the third core 214.

The electrical transformer may comprise one or more barrier structures positioned between transformer legs. For example, a first barrier structure 220 is positioned between the first higher voltage winding 206 of the first transformer leg and the second higher voltage winding 212 of the second transformer leg. A second barrier structure 222 is positioned between the second higher voltage winding 212 of the second transformer leg and the third higher voltage winding 218 of the third transformer leg. The barrier structures 220, 222 comprise a first material with a relatively lower permittivity value, such as a material having a permittivity value of about 2.5 or less (e.g., a permittivity value between about 2 and about 1). In an example, the barrier structures 220, 222 comprises a second material (not illustrated) with a relatively higher permittivity value, such as a material having a permittivity value of about 2.5 or more. The barrier structures 220, 222 may comprise any number of layers comprising the first material and/or the second material (e.g., a first layer comprising the first material, a second layer comprising the second material, etc.). The second material, having the relatively higher permittivity value, may provide puncture resistance while the first material, having the relatively lower permittivity value, may provide flashover resistance. For example, the first material may mitigate, due to having the relatively lower permittivity value, a flashover of arcs 252 between the first transformer leg and the second transformer leg and/or flashover of arcs 254 between the second transformer leg and the third transformer leg, which may otherwise cause an electrical failure.

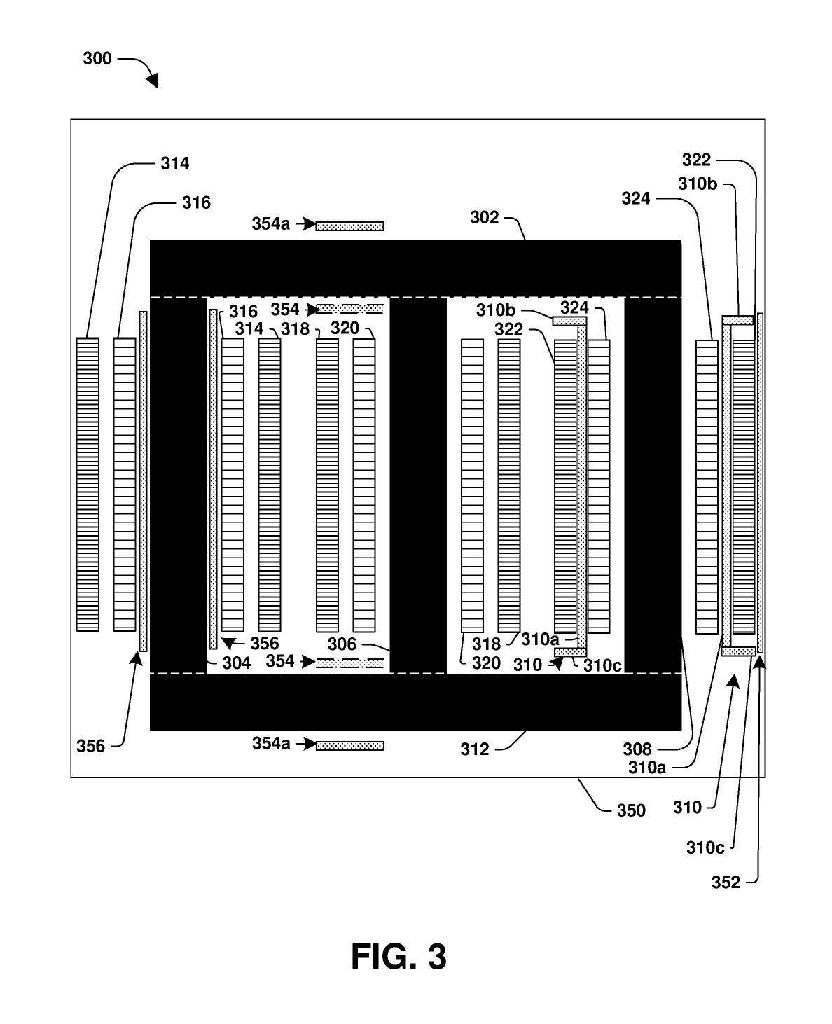

FIG. 3 illustrates an example 300 of a cross sectional view of an electrical transformer, such as a three phase transformer. The electrical transformer comprises a first transformer leg comprising a first core 304, a first lower voltage winding 316 wrapped around the first core 304, and a first higher voltage winding 314 wrapped around the first lower voltage winding 316 and the first core 304. The electrical transformer comprises a second transformer leg comprising a second core 306, a second lower voltage winding 320 wrapped around the second core 306, and a second higher voltage winding 318 wrapped around the second lower voltage winding 320 and the second core 306. The electrical transformer comprises a third transformer leg comprising a third core 308, a third lower voltage winding 324 wrapped around the third core 308, and a third higher voltage winding 322 wrapped around the third lower voltage winding 324 and the third core 308. The electrical transformer comprises a first core yoke 302 and a second core yoke 312. The first core 304, the second score 306, and the third core 308 may be positioned between, such as attached to and/or perpendicular to, the first core yoke 302 and the second core yoke 312.

The electrical transformer may comprise one or more barrier structures positioned between higher voltage windings and cores, such as between lower voltage windings and cores. For example, the electrical transformer comprise a barrier structure 310 positioned between the third higher voltage winding 322 and the third core 308, such as between the third lower voltage winding 324 and the third core 308. The barrier structure 310 may comprise a first material having a permittivity value of about 2.5 or less, such as about 2 or less.

In an example, the barrier structure 310 may comprise an angled ring shape. For example, the barrier structure 310 may comprise a first portion 310a extending substantially parallel to the third higher voltage winding 322 and/or the third lower voltage winding 324. The barrier structure 310 may comprise a second portion 310b connected to the first portion 310a. The second portion 310b may be substantially perpendicular to the first portion 310a. The second portion 310b may extend substantially parallel to the first core yoke 302. It may be appreciated that the second portion 310b may extend any length along the first core yoke 302, such as up to or beyond the third lower voltage winding 324, the third higher voltage winding 322, the second higher voltage winding 318, the second lower voltage winding 320, or the second core 306. The barrier structure 310 may comprise a third portion 310c connected to the first portion 310a. The third portion 310c may be substantially perpendicular to the first portion 310a. The third portion 310c may be substantially parallel with the second portion 310b. The third portion 310c may extend substantially parallel to the second core yoke 312. It may be appreciated that the third portion 310c may extend any length along the second core yoke 312, such as up to or beyond the third lower voltage winding 324, the third higher voltage winding 322, the second higher voltage winding 318, the second lower voltage winding 320, or the second core 306.

In another example of a barrier structure used to insulate a higher voltage winding from a yoke (e.g., the first core yoke 302 and the second core yoke 312), the barrier structure may comprise a U shaped barrier positioned 354 between the higher voltage winding and the yoke, where the U shaped barrier wraps around the yoke such that a bottom of the U shaped barrier is between the higher voltage winding and the yoke and two sides of the U shaped barrier are along a side of the yoke. In this way, the U shaped barrier is formed around the yoke (e.g., as opposed to being around the higher voltage winding). It may be appreciated that the U shaped barrier may extend any length along the yoke, and may wrap around any number of sides of the yoke, such as 3 or 4 sides (e.g., such as at position 354a).

In another example of a barrier structure, the barrier structure may comprise a flat sheet barrier positioned 354 between the higher voltage winding and the yoke (e.g., the first core yoke 302 and the second core yoke 312), where the flat sheet barrier wraps around the yoke such that a side of the flat sheet barrier is between the higher voltage winding and the yoke. It may be appreciated that the flat sheet barrier may extend any length along the yoke.

In another example of a barrier structure, the barrier structure is positioned 352 between a transformer winding, such as the third higher voltage winding 322, and a transformer enclosure 350 (e.g., at ground potential) of an electrical transformer. In this way, the barrier structure may insulate the third higher voltage winding 322 from a grounding portion of the inside of the transformer enclosure 350.

In another example of a barrier structure, the barrier structure is positioned 356 between a transformer winding, such as the first lower voltage winding 316, and the first core 304. In this way, the barrier structure may be stormed as a cylinder between the first lower voltage winding 316 and the first core 304.

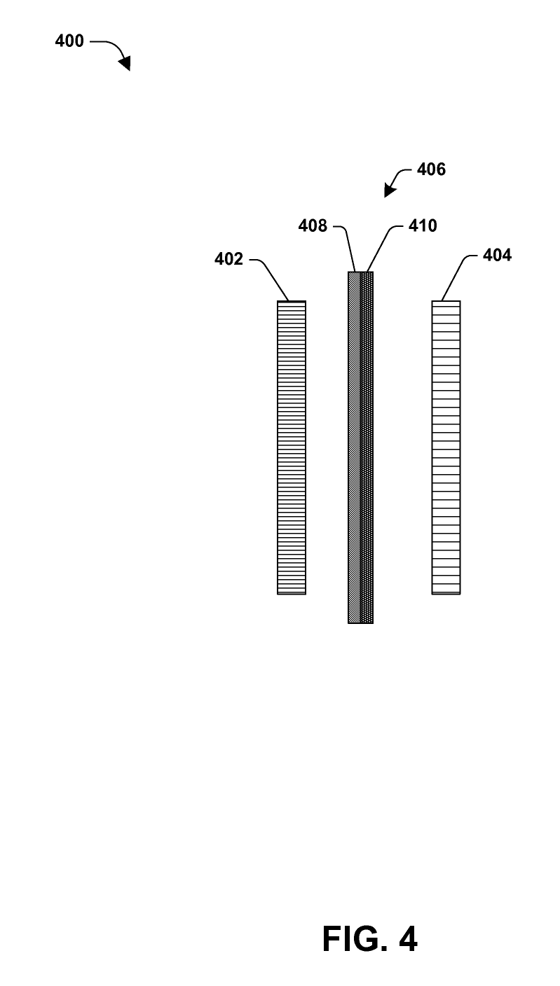

FIG. 4 illustrates an example of a barrier structure 406 positioned between a higher voltage winding 402 and a lower voltage winding 404. The barrier structure 406 comprises a first layer 408 comprising a first material having a permittivity value of about 2.5 or less, such as about 2 or less. The barrier structure 406 comprises a second layer 410 comprising a second material having a permittivity value of about 2.5 or great. The first layer 408 may provide improved flashover resistance due to the relatively low permittivity value, while the second layer 410 may provide improved puncture resistance due to the relatively higher permittivity value. It may be appreciated that the barrier structure 406 may comprise any number of layers in any order.

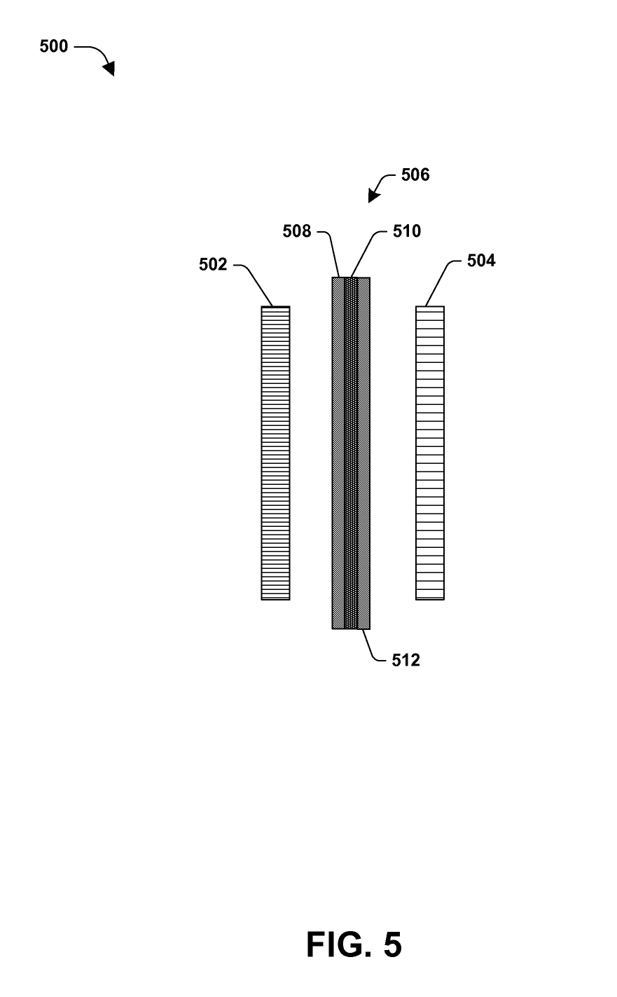

FIG. 5 illustrates an example of a barrier structure 506 positioned between a higher voltage winding 502 and a lower voltage winding 504. The barrier structure 506 comprises a first layer 508 comprising a first material having a permittivity value of about 2.5 or less, such as about 2 or less. The barrier structure 506 comprises a second layer 510 comprising a second material having a permittivity value of about 2.5 or great. The barrier structure comprises a third layer 512 comprising the first material. The first layer 508 and the third layer 512 may provide improved flashover resistance due to the relatively low permittivity value, while the second layer 510 may provide improved puncture resistance due to the relatively higher permittivity value. It may be appreciated that the barrier structure 506 may comprise any number of layers in any order.

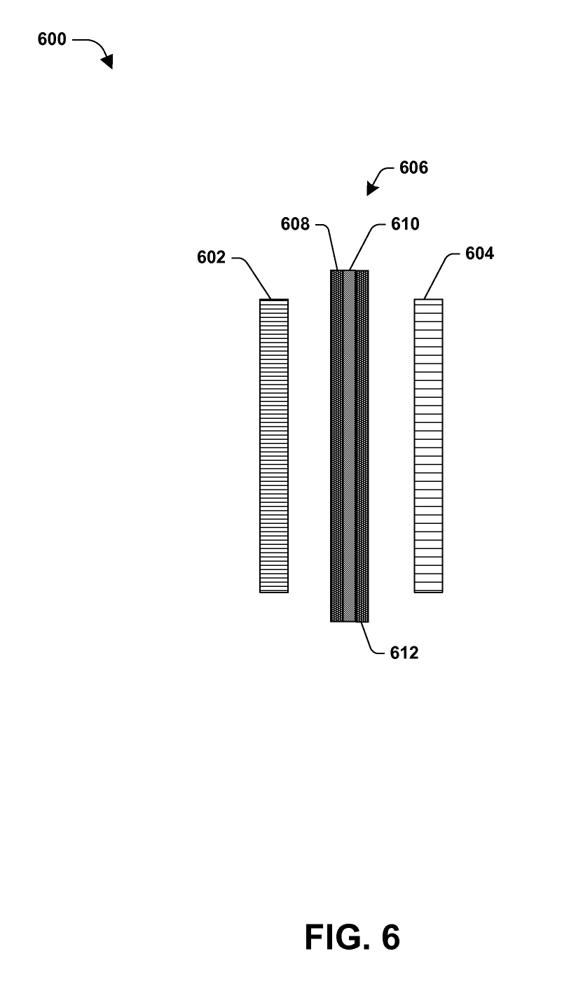

FIG. 6 illustrates an example of a barrier structure 606 positioned between a higher voltage winding 602 and a lower voltage winding 604. The barrier structure 606 comprises a first layer 608 comprising a first material having a permittivity value of about 2.5 or more. The barrier structure 606 comprises a second layer 610 comprising a second material having a permittivity value of about 2.5 or less, such as about 2 or less. The barrier structure comprises a third layer 612 comprising the first material. The second layer 610 may provide improved flashover resistance due to the relatively low permittivity value, while the first layer 608 and the third layer 612 may provide improved puncture resistance due to the relatively higher permittivity value. It may be appreciated that the barrier structure 606 may comprise any number of layers in any order.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally to be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. An electrical transformer, comprising:
a lower voltage winding wrapped around a core;
a higher voltage winding wrapped around the lower voltage winding and the core; and
a barrier structure positioned between the lower voltage winding and the higher voltage winding, the barrier structure comprising a first material having a permittivity value of about 2.5 or less.

2. The electrical transformer of claim 1, the first material comprising at least one of a polymeric foam insulation, a non-woven fibrous sheet, a Dacron sheet, pressboard, a laminate, uncalendered aramid paper, Nomax 411 paper, a fibre material, or a film.

3. The electrical transformer of claim 1, the barrier structure comprising a second material having a permittivity value of about 2.5 or greater.

4. The electrical transformer of claim 3, the barrier structure comprising the first material as a first layer and the second material as a second layer.

5. The electrical transformer of claim 4, the barrier structure comprising a third layer, the third layer comprising a third material having a permittivity value of about 2.5 or greater.

6. The electrical transformer of claim 1, the barrier structure comprising a first plurality of layers comprising one or more materials having permittivity values of about 2.5 or less and a second plurality of layers comprising one or more materials having permittivity values of about 2.5 or greater.

7. The electrical transformer of claim 1, the first material having a temperature resistivity of about 155 Celsius or greater.

8. The electrical transformer of claim 3, the second material comprising at least one of biaxial stretched polyester film, calendered aramid paper, a laminated film, polyimide film, a sheet insulation of composite material with polymer and inorganic filler, or a layering of polyester fiber and polyester film.

9. The electrical transformer of claim 1, the barrier structure comprising a cylindrical shape around the core.

10-14. (canceled)

15. An electrical transformer, comprising:
a lower voltage winding wrapped around a core;
a higher voltage winding wrapped around the lower voltage winding and the core; and
a barrier structure positioned between the higher voltage winding and the core, the barrier structure comprising a first material having a permittivity value of about 2.5 or less.

16. The electrical transformer of claim 15, the barrier structure positioned between the lower voltage winding and the core.

17. The electrical transformer of claim 15, the barrier structure positioned between the lower voltage winding and the higher voltage winding, the barrier structure comprising a U shape.

18. The electrical transformer of claim 15, the barrier structure comprising at least one of an angled ring shape, a U shape, or a flat sheet shape.

19. The electrical transform of claim 15, the barrier structure comprising a first portion extending substantially parallel to the high voltage winding, the barrier structure comprising a second portion connected to the first portion, the second portion substantially perpendicular to the first portion, the second portion extending substantially parallel to a core yoke, the core yoke substantially perpendicularly to the core.

20. The electrical transform of claim 19, the barrier structure comprising a third portion connected to the first portion, the third portion extending substantially parallel to a second core yoke, the second core yoke substantially perpendicularly to the core.

21. The electrical transformer of claim 15, comprising a second barrier structure positioned between the higher voltage winding and a transformer enclosure.

22. An electrical transformer, comprising:
a first lower voltage winding wrapped around a first core;
a first higher voltage winding wrapped around the first lower voltage winding and the first core;
a first barrier structure positioned between the first higher voltage winding and the first lower voltage winding;
a second lower voltage winding wrapped around a second core;
a second higher voltage winding wrapped around the second lower voltage winding and the second core; and
a second barrier structure positioned between the second lower voltage winding and the second core.

23. The electrical transformer of claim 22, the first barrier structure comprising a polymeric foam insulation.

24. The electrical transformer of claim 22, comprising a third barrier structure positioned between the first higher voltage winding and a transformer enclosure.

25. The electrical transformer of claim 22, the first barrier structure comprising at least one of an angled ring shape, a U shape, or a flat sheet shape.
